(19) United States
(12) Patent Application Publication
(10) Pub. No.: US 2006/0094860 A1
(43) Pub. Date: May 4, 2006

(54) InSb nanoparticle

(76) Inventor: Seiji Take, Tokyo-to (JP)

Correspondence Address: LADAS & PARRY LLP, 224 SOUTH MICHIGAN AVENUE, SUITE 1600, CHICAGO, IL, 60604, US

(21) Appl. No.: 11/262,357

(22) Filed: Oct. 28, 2005

(30) Foreign Application Priority Data
Nov. 1, 2004 (JP) 2004-318510

(51) Int. Cl. C08G 59/00; C08G 65/22

(52) U.S. Cl. 528/403; 528/402

(57) ABSTRACT

The main object of the present invention is to provide an InSb nanoparticle to be dispersed independently, InSb nanoparticle dispersion and a method for producing an InSb nanoparticle. The object of the present invention is achieved by providing an InSb nanoparticle having an average particle size in a range of 2 nm to 200 nm, capable of being dispersed and to be dispersed independently in a dispersion medium.

### BACKGROUND OF THE INVENTION

1. Field of the Invention

The present invention relates to an InSb nanoparticle to be used for a semiconductor, or the like.

2. Description of the Related Art

Since the InSb nanoparticles have a mobility of about 78,000 cm²/Vs, which is larger than the mobility of Si of 1,450 cm²/Vs, attention is paid thereto for the utilization to a semiconductor so that various synthesis methods have been studied. The synthesis methods for the inorganic nanoparticles can be roughly classified into the solid phase method, the liquid phase method and the gas phase method. As to the synthesis methods for the InSb nanoparticles, the liquid phase method and the gas phase method are known.

As to the synthesis method using the liquid phase method, for example, Solvothermal Reduction Synthesis reports the synthesis of the InSb nanoparticles of a 30 nm to 50 nm particle size by heating In and SbCl₃ to 180° C. to 300° C. with a benzene provided as the solvent (Adv. Mater., 13, p. 145-148 (2001)). Moreover, Solvothermal Reduction Synthesis mentioned above also reports synthesis of the InSb nanoparticles of a 40 nm to 60 nm particle size by heating InCl₃, 6 KBH₄ and Sb to 200° C. with an ethylene diamine provided as the solvent (Can. J. Chem., 79, p. 127-130 (2001)). Furthermore, synthesis of the InSb nanoparticles of an 11 nm particle size by the thermal decomposition of t-Bu₃In.Sb (SiMe₃)₃ has been reported (J. Cluster Science, 10, p 121-131 (1999)). The InSb nanoparticles obtained by these synthesis methods are of the secondary aggregation.

Moreover, as to the GaSb nanoparticles belonging to the III-V group semiconductor same as the InSb nanoparticles, synthesis of the GaSb nanoparticles of 10 nm to 50 nm particle size by reacting GaCl₃ and Sb (SiMe₃)₃ at the room temperature has been reported (Mater. Res. Bull., 34, p. 2,053-2,059 (1999)). It was also confirmed by the transmission electron microscope (TEM) photograph that the GaSb nanoparticles obtained by the synthesis method are secondarily aggregated.

Here, at the time of producing a semiconductor device, patterning of the semiconductor is needed, and thus the lithography method is used in general. As to the patterning technique, in addition to the lithography method, the ink jet method, the printing method, or the like can be presented. Since the ink jet method and the printing method do not include a complicated process as in the lithography method, it is advantageous in that the production process can be simplified.

However, it is difficult to use the secondarily aggregated InSb nanoparticles as mentioned above to the ink jet method or the printing method because an even coating film can hardly be obtained. Furthermore, blockage of the nozzle is generated in the case of the ink jet method, thus it is problematic.

On the other hand, as the synthesis method using the gas phase method, for example Molecular Beam Epitaxy (MBE) (Appl. Phys. Lett., 68, p. 958-960 (1996)), or Metal Organic Vapor Phase Deposition (MOVPE) (Appl. Phys. Lett., 74, p. 2,041-2,043 (1999)) report that the InSb nanoparticles (quantum dot) are formed on a GaAs substrate or a GaSb substrate, These methods utilize the phenomenon of spontaneous formation of the nanoparticles without forming a thin film of the InSb according to mismatching of the unit lattice of the GaAs or the GaSb and the InSb. However, according to these methods, since the InSb nanoparticles are fixed on the substrate, also in this case, it can hardly be used for the ink jet method or the printing method because it is difficult to disperse the InSb nanoparticles in a dispersion medium at the time of preparing the coating solution. Moreover, a problem is also involved in that the substrates capable of forming the InSb nanoparticles are limited and expensive.

Moreover, obtainment of a thin film with the InSb nanoparticles dispersed in the SiO₂ by the RF sputtering has been reported (Solid State Commun., 107, p. 79-84 (1998)). The thin film is a nonconductive thin film with the InSb nanoparticles dispersed on a limited solid film of the SiO₂. Therefore, since the InSb nanoparticles are fixed on the SiO₂ film, also as in the case mentioned above, it can hardly be used for the ink jet method or the printing method.

Furthermore, formation of the InSb nanoparticles by temporarily forming In nanoparticles on an amorphous carbon film and processing the Sb as an alloy by the vacuum deposition has been reported (PHILOSOPHILICAL MAGAZINE A, 80, p. 1,139-1,249 (2000)). However, according to the method, not only the InSb nanoparticles but also the Sb nanoparticles are formed, and thus it is difficult to obtain only the InSb nanoparticles. Moreover, since the InSb nanoparticles are fixed on the amorphous carbon film, as in the case, it can hardly be used for the ink jet method of the printing method. Furthermore, another problem is involved in that the substrates capable of forming the InSb nanoparticles are limited.

Therefore, establishment of a synthesis method capable of obtaining the InSb nanoparticles to be used for the ink jet method, the printing method, or the like has been called for.

### SUMMARY OF THE INVENTION

The main object of the present invention is to provide an InSb nanoparticle, InSb nanoparticle dispersion and a method for producing an InSb nanoparticle to be used for, for example, the ink jet method and the printing method.

As a result of the elaborate discussion on the circumstances, the present inventors have found out that InSb nanoparticle which is capable of being dispersed and to be dispersed independently in a dispersion medium can be synthesized by the use of the hot soap method as the method for producing an InSb nanoparticle so as to achieve the present invention.

That is, the present invention provides an InSb nanoparticle having the average particle size in a range of 2 nm to 200 nm, capable of being dispersed and to be dispersed independently in a dispersion medium.

Since the InSb nanoparticle of the present invention is dispersed independently, by use of such an InSb nanoparticle, film formation or patterning of the InSb having a high mobility can be carried out easily.

According to the invention, it is preferable that an organic compound having one or more residues of a hydrophilic group and a hydrophobic group in one molecule is adhered on the surface. Since a predetermined organic compound is adhered on the surface of the InSb nanoparticle, aggregation of the InSb nanoparticle can be prevented.

Moreover, the present invention provides an InSb nanoparticle having one or more residues of a hydrophilic group and a hydrophobic group in one molecule adhered on the surface.

According to the present invention, since a predetermined organic compound is adhered on the surface of the InSb nanoparticle, aggregation of the InSb nanoparticle can be prevented. Thereby, since an InSb nanoparticle independently dispersed can be provided, film formation or patterning of the InSb having a high mobility can be carried out easily.

Moreover, according to the present invention, it is preferable that the hydrophilic group is an amino group, a carboxyl group or a hydroxyl group. In general, these hydrophilic groups have a high affinity with respect to a metal.

Furthermore, the present invention provides an InSb nanoparticle dispersion containing an InSb nanoparticle and a dispersion medium. At the time, it is preferable that the InSb nanoparticle is dispersed independently in the dispersion medium.

According to the present invention, since the InSb nanoparticle is dispersed independently in the dispersion medium, for example in the case of forming a semiconductor by coating the InSb nanoparticle dispersion of the present invention, it is advantageous in that an even coating film can be obtained. In particular, it is advantageous in the case of patterning a semiconductor by the ink jet method or the printing method. Compared with the case of the conventional lithography method, patterning can be facilitated so that the production process can be simplified.

According to the invention, the InSb nanoparticle may have an organic compound having a hydrophilic group and a hydrophobic group in one molecule adhered on the surface and the dispersion medium may be a non polar solvent. According to the configuration, aggregation of the InSb nanoparticle can be prevented effectively.

Moreover, according to the invention, the InSb nanoparticle may have an organic compound having a hydrophilic group and a hydrophobic group in one molecule with the hydrophilic group bonded to the both ends of the hydrophobic group adhered on the surface and the dispersion medium may be a polar solvent. According to the configuration, aggregation of the InSb nanoparticle can be prevented effectively.

Furthermore, the present invention provides a method for producing an InSb nanoparticle, wherein an InSb nanoparticle is produced by the hot soap method. According to the present invention, since the hot soap method is used, the InSb nanoparticle independently dispersed can be obtained.

According to the invention, it is preferable to use at least one organic compound selected from the group consisting of amino alkanes, higher fatty acids, and higher alcohols in the hot soap method. Thereby, the InSb nanoparticle independently dispersed can easily be obtained.

Moreover, according to the invention, it is preferable to use higher alcohols having one or more residues of a long chain alkyl group and two or more residues of a hydroxyl group in one molecule in the hot soap method. For producing an InSb nanoparticle, in general an antimony compound is used. In the case an antimony alkoxide is used as the antimony compound, by use of the higher alcohols, the antimony alkoxide can be stabilized so that precipitation of an antimony oxide can be restrained.

According to the present invention, since the hot soap method is used, the InSb nanoparticle independently dispersed can be obtained. Thereby, the effect of being advantageous at the time of patterning an InSb semiconductor having a high mobility can be achieved.

### BRIEF DESCRIPTION OF THE DRAWINGS

FIGS. 1A and 1B an example of TEM photograph s of an InSb nanoparticle of the present invention.

FIG. 2 is an example of an X ray diffraction pattern of an InSb nanoparticle of the present invention.

### DESCRIPTION OF THE PREFERRED EMBODIMENT

Hereinafter, InSb nanoparticles, InSb nanoparticle dispersion and a method for producing an InSb nanoparticle of the present invention will be explained in detail.

A. InSb Nanoparticle

The InSb nanoparticle of the present invention can be classified into two embodiments. Hereinafter, each embodiment will be explained.

### 1. First Embodiment

An InSb nanoparticle of this embodiment has the average particle size in a range of 2 nm to 200 nm, capable of being dispersed and to be dispersed independently in a dispersion medium.

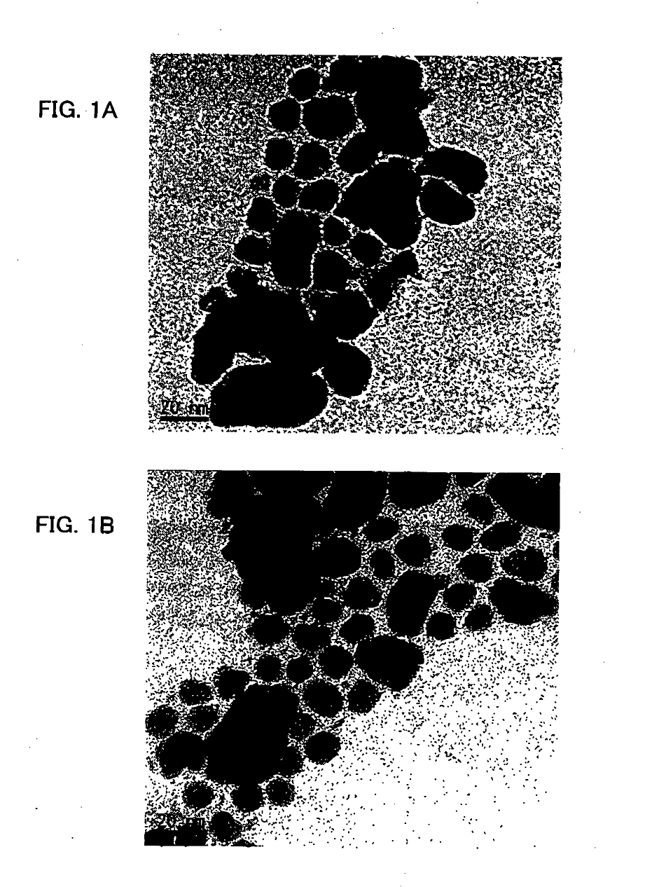

FIGS. 1A and 1B show an example of transmission electron microscope (TEM) photographs of an InSb nanoparticle of this embodiment. As shown in FIGS. 1A and 1B, as for the InSb nanoparticle of this embodiment, each particle is dispersed independently without secondary aggregation. Accordingly, since the InSb nanoparticle is dispersed independently, it can be dispersed stably in a dispersion medium compared with the case of the secondary aggregated InSb nanoparticle. Therefore, the InSb nanoparticle dispersed independently can be used preferably as a semiconductor forming material.

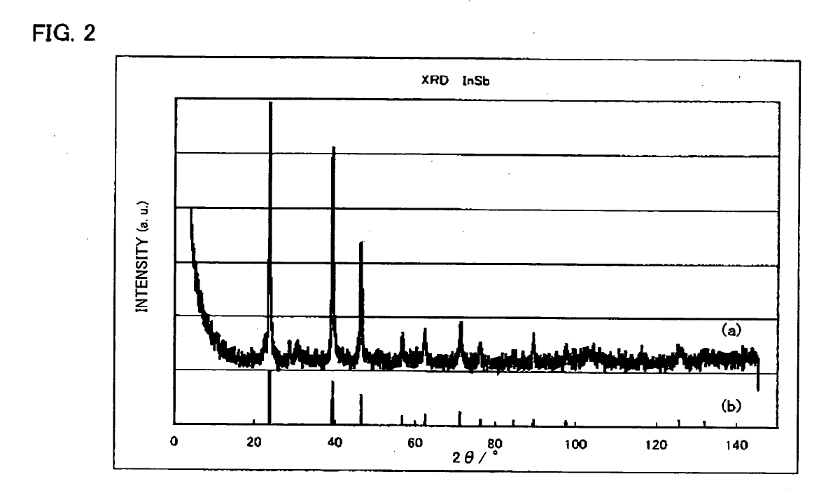

The independent dispersion of the InSb nanoparticle can be confirmed by the observation using the transmission electron microscope (TEM) as mentioned above. For example, as shown by the TEM photograph of FIG. 1A, if the particles are not superimposed, the InSb nanoparticles are dispersed independently. On the other hand, for example, as shown in the TEM photograph of Adv. Mater., 13, p. 145-148 (2001) FIG. 2A-B, or the TEM photograph of Can. J. Chem., 79, p. 127-130 (2001) FIG. 2A-C, if the particles are superimposed, the InSb nanoparticles are secondarily aggregated.

Moreover, the InSb nanoparticle of this embodiment can be dispersed in a dispersion medium. Here, “can be dispersed in a dispersion medium” denotes that the InSb nanoparticle itself is present as a minute particle so that it can be dispersed in a predetermined dispersion medium.

Since the dispersion medium is the same as that in the item of “B. InSb nanoparticle dispersion liquid” to be described, the explanation thereof is omitted here.

Moreover, according to the InSb nanoparticle of this embodiment, it is preferable that an organic compound having one or more residues of a hydrophilic group and a hydrophobic group in one molecule is adhered on the surface. Since a predetermined organic compound is adhered on the surface of the InSb nanoparticle, aggregation of the InSb nanoparticle can be prevented.

On the other hand, in the case the InSb nanoparticle does not have a predetermined organic compound adhered on the surface, by adding a predetermined organic compound at the time of dispersing in a dispersion medium, aggregation of the InSb nanoparticle can be prevented.

The predetermined organic compound to be adhered on the surface of the InSb nanoparticle is not particularly limited as long as it has one or more residues of a hydrophilic group and a hydrophobic group in one molecule. However, an organic compound having a hydrophilic group bonded to one end or the both ends of the hydrophobic group is preferable.

As the hydrophobic group, for example, an aliphatic hydrocarbon group having 4 or more carbons; an aromatic hydrocarbon group such as a phenyl group and a naphthyl group; a heterocyclic group such as a pyridyl group, a pyrrole group and a thiophene group; or the like can be presented. Moreover, the hydrophobic group may be a residue of these groups.

Among the examples, the hydrophobic group is preferably an aliphatic hydrocarbon group. Although the aliphatic hydrocarbon group may either by chain or cyclic, it is preferably chain. Moreover, the chain aliphatic hydrocarbon group may either be straight chain or branched. Furthermore, the aliphatic hydrocarbon group may either be unsaturated or saturated.

As to the number of carbons of such a chain aliphatic hydrocarbon group, the number of carbon atoms in the straight chain excluding the branched carbon is, in general, in a range of 6 to 30 and it is more preferably in a range of 8 to 20.

Moreover, the hydrophilic group is not particularly limited as long as it is a functional group capable of adhering onto the surface of the InSb nanoparticle. For example, a carboxyl group, an amino group, a hydroxyl group, a thiol group, an aldehyde group, a sulfonic acid group, an amide group, a sulfon amide group, a phosphoric acid group, a phosphine group, a P═O group, or the like can be presented. Among the examples, the hydrophilic group is preferably a carboxyl group, an amino group or a hydroxyl group. In general, a carboxyl group, an amino group and a hydroxyl group has a high affinity with respect to a metal. Moreover, the organic compounds having these hydrophilic groups are easily accessible.

As the predetermined organic compound, specifically, an organic compound to be stabilized by being coordinated to an InSb microcrystal in a dispersion medium can be used. As such an organic compound, for example, amino alkanes such as an octyl amine, a decyl amine, a dodecyl amine, a tetradecyl amine, a hexadecyl amine, and an octadecyl amine; higher fatty acids such as a palmitic acid, a stearic acid, and an oleic acid; higher alcohols; or the like can be presented as preferable examples. This is because, as mentioned above, the hydrophilic group of the predetermined organic compounds is preferably an amino group, a carboxyl group or a hydroxyl group.

The higher alcohols are preferably one having one or more residues of a long chain alkyl group and two or more residues of a hydroxyl group in one molecule. For example, a long chain alkyl-1,2-diol, or the like can be presented. As it will be mentioned in the item of “C. Method for producing an InSb nanoparticle” to be described later, at the time of synthesizing an InSb nanoparticle by the hot soap method, in the case an antimony alkoxide is used as the precursor, the antimony alkoxide can be stabilized by the use of a long chain alkyl-1,2-diol, or the like.

The organic compound may be adhered alone onto the surface of the InSb nanoparticle, or a plurality of organic compounds may also be adhered onto the surface of the InSb nanoparticle. Further, the amount of the organic compound adhered to the InSb nanoparticle is not particularly limited.

Further, the predetermined organic compound is merely adhered onto the surface of the InSb nanoparticle. The “adhesion” here includes also the cases of having a predetermined organic compound adsorbed or coordinated to the surface of the InSb nanoparticle.

The adhesion of the predetermined organic compound onto the surface of the InSb nanoparticle can be confirmed by preliminarily confirming the dispersion of the InSb nanoparticle in a dispersion medium and examining the inclusion of a carbon and an element corresponding to a hydrophilic group using the X ray photoelectron spectrometry (XPS) as one of the surface analysis methods concerning the InSb nanoparticle.

The average particle size of the InSb nanoparticles of the present embodiment is in a range of 2 nm to 200 nm. More preferably it is in a range of 3 nm to 100 nm, and particularly preferably it is in a range of 5 nm to 50 nm. In the case the average particle size is too small, production is difficult. On the other hand, in the case the average particle size is too large, dispersion in a dispersion medium may be difficult.

The above-mentioned average particle size is the value obtained by selecting an area confirmed to have the presence of 20 or more InSb nanoparticles among the images obtained using a scanning electron microscope (SEM) or a transmission electron microscope (TEM) for the InSb nanoparticle, measuring the particle sizes of the all InSb nanoparticles in the area, and calculating the average value. However, the InSb nanoparticles not focused appropriately and blurred are excluded from the measurement subject. Moreover, in the case the InSb nanoparticle has a shape other than spherical such as bar-like, the largest size and the smallest size are measured for each particle so as to have the average value thereof as the average particle size.

Furthermore, the InSb nanoparticle may either be crystalline or amorphous, but it is particularly preferably be crystalline. By the InSb nanoparticle being crystalline, the mobility can be made higher. On the other hand, in the case the InSb nanoparticle is amorphous, the InSb nanoparticle can be processed to be crystalline by for example heating at the time of using the InSb nanoparticle of the present embodiment for the semiconductor forming material.

Whether or not the InSb nanoparticle being crystalline can be confirmed by the X ray diffraction analysis.

Moreover, the InSb nanoparticle of this embodiment may have a minute amount of a predetermined element doped. The InSb in general as an n type semiconductor material, may be used as a n type semiconductor material or a p type semiconductor material by doping a minute amount of an element.

In the case the InSb nanoparticle is used as a n type semiconductor forming material, as the elements to be doped, for example, S, Se, Te, or the like can be presented. On the other hand, in the case the InSb nanoparticle is used as a p type semiconductor forming material, as the elements to be doped, for example, Zn, Cd, Hg of the 12 group, the transition elements of the 3 to 11 groups, or the like can be presented. As the transition metal elements, for example, Cr, Mn, Fe, Co, Ni, Cu, or the like can be presented.

As the applications for the InSb nanoparticles of the present embodiment, for example, a semiconductor forming material, a wiring material, a diode, a transistor, or the like, utilizing the high mobility can be presented. Moreover, even in the case a mobility higher than Si cannot be realized, by achieving a mobility of 1 cm²/Vs or higher as the mobility of the organic semiconductor to be formed by coating, it can be applied for the display, or the like requiring a large number of transistors in a large area.

Moreover, it is preferable that the InSb nanoparticle of the present embodiment is produced by the hot soap method. By using the hot soap method, the InSb nanoparticles independently dispersed can be obtained. Since the method for producing an InSb nanoparticle by the hot soap method will be disclosed in the item of “C. Method for producing the InSb nanoparticle” to be described below, explanation thereof is omitted here.

### 2. Second Embodiment

The InSb nanoparticle of this embodiment has an organic compound having one or more residues of a hydrophilic group and a hydrophobic group in one molecule adhered on the surface.

In this embodiment, as it is mentioned in the item of the first embodiment, since the predetermined organic compound is adhered onto the surface of the InSb nanoparticle, aggregation of the InSb nanoparticle can be prevented. Thereby, since it can be dispersed stably in a dispersion medium, the InSb nanoparticle of this embodiment can be used preferably as a semiconductor forming material.

Since the other points of the InSb nanoparticle is the same as those of the first embodiment, the explanation thereof is not repeated here.

B. InSb Nanoparticle Dispersion

Next, the InSb nanoparticle dispersion of the present invention will be explained. The InSb nanoparticle dispersion of the present invention contains an InSb nanoparticle and a dispersion medium.

The InSb nanoparticle dispersion of the present invention is not particularly limited as long as it contains an InSb nanoparticle and a dispersion medium. The InSb nanoparticle may either be dispersed or precipitated in the dispersion medium.

In particular, according to the present invention, it is preferable that the InSb nanoparticle is dispersed independently in a dispersion medium. Here, “the InSb nanoparticle is dispersed independently in a dispersion medium” denotes that the InSb nanoparticle is not precipitated for 1 hour or more in the dispersion medium at the used temperature of the InSb nanoparticle dispersion. For example, at the time of using the InSb nanoparticle dispersion for coating or patterning, the used temperature is in general in a range of 0° C. to 40° C.

Accordingly, if the InSb nanoparticle is dispersed independently in the dispersion medium without precipitation for a predetermined time, in the case of for example forming a semiconductor by coating the InSb nanoparticle dispersion of the present invention, it is advantageous in that an even coating film can be obtained. In particular, it is advantageous in the case of patterning a semiconductor by the ink jet method or the printing method. Moreover, since the semiconductor can be patterned by the ink jet method or the printing method, compared with the case by the conventional lithography method, the patterning operation can be facilitated so that the production process can be simplified.

On the other hand, in the case the InSb nanoparticle of the InSb nanoparticle dispersion of the present invention is precipitated in the dispersion medium, the InSb nanoparticle can be dispersed independently in the dispersion medium by further diluting with the dispersion liquid immediately before use. Moreover, by adding a predetermined organic compound at the time of using the InSb nanoparticle dispersion, the InSb nanoparticle can be dispersed independently in the dispersion medium. Therefore, the same effects as the case of the InSb nanoparticle independently dispersed in the dispersion medium can be obtained.

Hereinafter, each configuration of the InSb nanoparticle dispersion of the present invention is explained.

(1) InSb Nanoparticle

The InSb nanoparticle used in the present invention is not particularly limited as long as it can be dispersed independently in the dispersion medium to be described later, that is, it is not precipitated for predetermined time or longer. It is preferably one having an organic compound having one or more residues of a hydrophilic group and a hydrophobic group in one molecule adhered on the surface. Since such an organic compound is adhered on the surface, aggregation of the InSb nanoparticle can be prevented effectively.

On the other hand, in the case the predetermined organic compound is not adhered on the surface of the InSb nanoparticle, by adding the predetermined organic compound at the time of using the InSb nanoparticle dispersion, aggregation of the InSb nanoparticle can be prevented.

Since the InSb nanoparticle is the same as that of the item of “A. InSb nanoparticle”, the explanation thereof is not repeated here.

As mentioned above, the InSb nanoparticle is not precipitated for one hour or more in a dispersion medium at the used temperature of the InSb nanoparticle dispersion. It is not precipitated preferably for 6 hours or more, particularly preferably for 12 hours or more. Such an InSb nanoparticle dispersion containing the InSb nanoparticle is advantageous in the case of patterning a semiconductor by the Ink jet method or the printing method.

The time is the value obtained by measuring the time of observing visually the precipitation in the bottom part of the container with the InSb nanoparticle dispersion placed in a transparent container disposed still at a horizontal place.

Moreover, the content of the InSb nanoparticle in the InSb nanoparticle dispersion is not particularly limited, and it is preferably an amount capable of maintaining the InSb nanoparticle independent dispersion state. Specifically, the content of the InSb nanoparticle is preferably 10% by weight or less in the InSb nanoparticle dispersion, it is more preferably 5% by weight or less, and it is most preferably 1% by weight or less. The lower limit is 0.01% by weight or more, and it is preferably 0.05% by weight or more. In the case the content of the InSb nanoparticle is too large, it may be over saturated so that the InSb nanoparticle independent dispersion state may not be maintained. On the other hand, in the case the content of the InSb nanoparticle is too small, formation of the semiconductor using the InSb nanoparticle dispersion of the present invention may be difficult.

(2) Dispersion Medium

The dispersion medium used in the present invention is not particularly limited as long as the InSb nanoparticle can be dispersed independently. In the case the predetermined organic compound is adhered on the surface of the InSb nanoparticle, or the predetermined organic compound is added to the InSb nanoparticle dispersion, it can be selected optionally according to the kind of the predetermined organic compound.

For example, in the case the predetermined organic compound has a hydrophilic group and a hydrophobic group in one molecule, with the hydrophilic group bonded to one end of the hydrophobic group, it is preferable that the dispersion medium has a low polarity. This is because the organic compound is assumed to be adhered onto the InSb nanoparticle with the hydrophilic group provided to the inner side (InSb nanoparticle side) and the hydrophobic group provided to the outer side according to the interaction of the hydrophilic group of the organic compound with the InSb nanoparticle. Therefore, the surface of the InSb nanoparticle is in a state covered with the hydrophobic group. Accordingly, with a dispersion medium having a low polarity, the interaction with the hydrophobic group can be facilitated so that the InSb nanoparticle covered with the hydrophobic group can easily be dispersed independently.

The dispersion medium having a low polarity is not particularly limited as long as it is a non polar solvent. For example, the solvents having less than 10 dissolution parameter: δ disclosed in “Yozai Handbook” (solvent handbook) (edited by Teruzo ASAHARA, et al., Kodansha Ltd.), p. 34 are preferable. Specifically, aliphatic hydrocarbons such as a pentane, a cyclopentane, a hexane, a cyclohexane, an octane, and an isooctane; aromatic hydrocarbons such as a benzene, a toluene and a xylene; halogenated hydrocarbons such as a dichloro methane, a carbon tetrachloride, a chloroform, a 1,2-dichloro ethane, a propyl chloride, a chloro benzene, a bromo benzene and a methyl iodide; ethers such as a diethyl ether, a diisopropyl ether, a tetrahydro furan and a dioxane; esters such as an ethyl acetate and a methyl benzoate; ketones such as an acetone and a methyl ethyl ketone; amines such as a triethyl amine and a propyl amine; a diethyl sulfide; a mixture thereof, or the like can be presented. Among these examples, a toluene, a chloroform, a hexane, or the like can be used preferably.

For example, in the case the predetermined organic compound has a hydrophilic group and a hydrophobic group in one molecule with the hydrophilic group bonded to the both ends of the hydrophobic group, it is preferable that the dispersion medium has a high polarity. This is because the organic compound is assumed to be adhered to the InSb nanoparticle with the hydrophilic group of one side provided to the inner side (InSb nanoparticle side) and the hydrophilic of the other side provided to the outer side via the hydrophobic group according to the interaction of the hydrophilic group on one side of the organic compound with the InSb nanoparticle. Therefore, the surface of the InSb nanoparticle is in a state covered with the hydrophilic group. Therefore, with a dispersion medium having a high polarity, the interaction with the hydrophilic group can be facilitated so that the InSb nanoparticle covered with the hydrophilic group can easily be dispersed independently.

The dispersion medium having a high polarity is not particularly limited as long as it is a polar solvent. For example, the solvents having more than 10 dissolution parameter: δ disclosed in “Yozai Handbook” (solvent handbook) (edited by Teruzo ASAHARA, et al., Kodansha Ltd.), p. 34 are preferable. Specifically, alcohols such as a methanol, an ethanol, a 1-propanol, a 2-propanol, a 1-butanol, a 2-butanol, a tert-butyl alcohol, a phenol, and a 1,2-ethanediol; amides such as a formamide, a N,N-dimethyl formamide, and a N,N-dimethyl acetoamide; nitro group containing compounds such as a nitro methane and a nitrobenzene; nitrile group containing compounds such as an acetonitrile, a 1,3-dicyano propane, and a benzonitrile; a pyridine; a propylene carbonate; a 2-amino ethanol; water; an acetic acid; a mixture thereof, or the like can be presented. Among these examples, a N,N-dimethyl formamide, a 2-propanol, and an acetonitrile can be used preferably.

(3) Dispersibility Improving Agent

In the present invention, a dispersibility improving agent for improving the dispersibility of the InSb nanoparticle can be added to the InSb nanoparticle dispersion. As the dispersibilityy improving agent, the amino alkanes, the higher fatty acids, the higher alcohols, or the like mentioned in the item of “A. InSb nanoparticle” can be used.

(4) Application

The InSb nanoparticle dispersion of the present invention is advantageous in the case of patterning a semiconductor. For example, it can be used in the case of producing a thin film transistor (TFT), an IC (integrated circuit), a thin film transistor (TFT) for a liquid crystal display of the active matrix display, or the like.

C. Method for Producing the InSb Nanoparticle

Next, the method for producing an InSb nanoparticle of the present invention will be explained. According to the production method for an InSb nanoparticle of the present invention, an InSb nanoparticle is produced by the hot soap method.

Here, the hot soap method is a method of promoting the crystal core formation and the crystal growth by the reaction commenced as a result of the thermal decomposition of at least one kind of a precursor of a compound to be targeted in a dispersing agent heated to a high temperature. For the purpose of controlling the reaction rate of the processes of the core formation and the crystal growth of the crystal, a dispersing agent having an appropriate coordination force to the constituent elements of a targeted compound is used as the essential component for providing a liquid phase medium. Since the state of stabilizing the crystal by coordination with the dispersing agent is similar to the state of stabilizing oil droplet in water by the soap molecules, this reaction is referred to as the hot soap method.

In the present invention, by using the hot soap method, the InSb nanoparticles independently dispersed can be obtained, and thus it is advantageous. In the case of the InSb nanoparticles is InSb nanoparticles independently dispersed, the mobility can be made higher.

In the present invention, in order to produce the InSb nanoparticles using the hot soap method, a method of heating a dispersing agent and injecting a precursor including the constituent elements of the InSb nanoparticles to the heated dispersing agent can be used.

Hereinafter each constituent of the method for producing an InSb nanoparticle of the present invention will be explained.

(1) Precursor

The precursor used in the present invention is not particularly limited as long as the InSb nanoparticle can be formed. In general, an indium compound and an antimony compound are used. At the time, the mixing ratio of the indium compound and the antimony compound can be set based on the stoichiometric ratio.

The indium compound used for the precursor is not particularly limited as long as it can be dissolved evenly in the dispersing agent to be described later. For example, an organic metal compound of an indium can be presented. Specifically, an indium acetyl acetonate, an indium acetate, a cyclopentadienyl indium, an indium alkoxide, an indium chloride, or the like can be used.

Moreover, the antimony compound to be used for the precursor is not particularly limited as long as it is dissolved evenly in a dispersing agent to be described later. For example, an organometal compound of an antimony can be presented. Specifically, an antimony alkoxide, an antimony acetate, an antimony triphenyl, antimony trimethyl silyl, or the like can be used.

The precursor used in the present invention may either be a gas, a liquid or a solid at an ordinary temperature. In the case the precursor is liquid at an ordinary temperature, since it can be used as it is, it is advantageous in terms of the convenience in the production operation.

Moreover, in the case the precursor is solid or liquid at a room temperature, it may be used in a state dissolved or dispersed in a solvent as needed. As such a solvent, alkanes such as a n-hexane, a n-heptane, a n-octane, an isooctane, a nonane, and a decane, aromatic hydrocarbons such as a benzene, a toluene, a xylene and a naphthalene, ethers such as a diphenyl ether and a di (n-octyl) ether, halogen based hydrocarbons such as a chloroform, a dichloromethane, a dichloroethane, a monochlorobenzene, and a dichlorobenzene, amines such as a n-hexyl amine, a n-octyl amine, a tri(n-hexyl) amine, and a tri(n-octyl) amine, alcohols, compounds to be used for a dispersing agent to be described later, or the like can be presented. Among these examples, the halogen based hydrocarbons, the alcohols, or the amines can be used preferably.

Furthermore, in the case at least one kind of the precursors is a gas, it may be introduced into the solvent mentioned above or a dispersing agent to be described later by being dissolved by bubbling, or the like, or the gas may be introduced directly into a reaction liquid phase with the other precursors injected.

(2) Dispersing Agent

The dispersing agent used in the present invention is not particularly limited as long as it is a substance to be stabilized by the coordination to microcrystals in a high temperature liquid phase. For example, trialkyl phosphines such as a tributyl phosphine, a trihexyl phosphine, and a trioctyl phosphine, organic phosphorous compounds such as a tributyl phosphine oxide, a trihexyl phosphine oxide, a trioctyl phosphine oxide and a tridecyl phosphine oxide, amino alkanes such as an octyl amine, a decyl amine, a dodecyl amine, a tetradecyl amine, a hexadecyl amine and an octadecyl amine, tertiary amines such as a tri(n-hexyl) amine, and a tri(n-octyl) amine, organic nitrogen compounds such as an aromatic compound including a nitrogen like a pyridine, a lutidine, a collidine, and quinolines, dialkyl sulfides such as a dibutyle sulfide, dialkyl sulfoxides such as a dimethyl sulfoxide and a dibutyl sulfoxide, organic sulfur compounds such as an aromatic compound including a sulfur like a thiophene, higher fatty acids such as a palmitic acid, a stearic acid and an oleic acid, alcohols, or the like can be presented.

Moreover, in the present invention, in the case an antimony alkoxide is used as the precursor, it is preferable to use higher alcohols having one or more residues of a long chain alkyl group and two or more residues of a hydroxyl group in one molecule as the dispersing agent. Since such higher alcohols are used, the antimony alkoxide can be stabilized so that precipitation of the antimony oxide can be restrained. As the higher alcohols, specifically, a long chain alkyl-1,2-diol, or the like can be presented. The number of carbons of the long chain alkyl group of the long chain alkyl-1,2-diol is in general in a range of 12 to 30.

Among the examples, in the present invention, it is preferable to use at least one kind of the organic compound selected from the group consisting of the amino alkanes, the higher fatty acids and the higher alcohols. The amino alkanes, the higher fatty acids and the higher alcohols have a hydrocarbon bonded with an amino group, a carboxyl group or a hydroxyl group. The hydrocarbon in this case may either be chain or cyclic. Moreover, in the case it is chain, it may either be straight chain or branched, but it is preferably straight chain. Furthermore, the number of carbons of the hydrocarbon is in general in a range of 12 to 30, and the number of carbons is particularly preferably in a range of 14 to 20. By using such an organic compound, the InSb nanoparticle dispersed independently can easily be obtained.

The dispersing agents mentoned above may be used alone or as a mixture of a plurality of kinds as needed.

Moreover, according to the present invention, it is preferable to use the amino alkanes, the higher fatty acids and the higher alcohols having one or more residues of the long chain alkyl group and two or more residues of the hydroxyl group in one molecule as a mixture out of the dispersing agents.

Moreover, the dispersing agent may be diluted with a solvent and used. The solvent to be used is appropriately selected in accordance with producing condition for the InSb nanoparticle. For example, aromatic hydrocarbons such as a toluene, a xylene and a naphthalene, long chain alkanes such as an octane, a decane, a dodecane, and an octadecane, ethers such as a diphenyl ether, a di(n-octyl) ether, a di(n-octadecyl) ether, and a tetrahydrofuran, a halogen based hydrocarbon, or the like can be presented.

(3) Method for Producing the InSb Nanoparticle

In the present invention, an InSb nanoparticle can be produced by heating the dispersing agent and injecting the precursor to the heated dispersing agent.

The heating temperature for the dispersing agent is not particularly limited as long as it is a temperature capable of melting the dispersing agent and precursor. Although it may vary depending upon the pressure condition, or the like, it is in general 100° C. or higher, preferably 200° C. or higher, or more preferably 250° C. or higher. Moreover, it is preferable that the heating temperature is relatively high. By setting the same at a high temperature so as to decompose the precursor injected to the dispersing agent collectively, a large number of cores are produced at the same time, and thus an InSb nanoparticle having a relatively small particle size can easily be obtained.

Moreover, the method for injecting the precursor to the heated dispersing agent is not particularly limited as long as it is a method capable of forming an InSb nanoparticle. Moreover, it is preferable to carry out the precursor injection for one time further preferably within a short time in order to obtain an InSb nanoparticle having a relatively small particle size. In the case of having a large particle size, the injection may be executed by a plurality of times and it may be carried out continuously.

The reaction temperature at the time of forming the InSb nanoparticle after injecting the precursor to the heated dispersing agent is not particularly limited as long as it is a temperature capable of melting the dispersing agent and precursor or dissolving the same in a solvent, and capable of generating the crystal growth. Although it may vary depending upon the pressure condition, or the like, it is in general 100° C. or higher, preferably 150° C. or higher, or more preferably 200° C. or higher.

After producing the InSb nanoparticle by injecting the precursor to the dispersing agent as mentioned above, in general the InSb nanoparticle is separated from the dispersing agent. As the separation method, for example, the sedimentation methods such as the centrifugal separation, the floatation and the foam separation, the filtration methods such as the cake filtration and the clarifying filtration, and the squeeze method can be presented. In the present invention, among the above-mentioned examples, the centrifugal separation can be used preferably. However, the InSb nanoparticles obtained after the separating operation are obtained in many cases as a mixture with a small amount of a dispersing agent. Therefore, the InSb nanoparticle with the predetermined organic compound, that is, the dispersing agent adhered on the surface can be obtained.

At the time of the separation, in the case the sedimentation of the InSb nanoparticles is difficult due to too small a size of the InSb nanoparticles, in order to improve the sedimentation property, additives like alcohols having 1 to 4 carbons such as an acetonitrile, a methanol, an ethanol, a n-propyl alcohol, an isopropyl alcohol, a n-butyl alcohol, an isobutyl alcohol, a secondary butyl alcohol and a tert butyl alcohol, aldehydes having 1 to 4 carbons such as a formaldehyde, an acetaldehyde, an acrolein, and a crotonaldehyde, ketones having 3 to 5 carbons such as an acetone, a methyl ethyl ketone, and a diethyl ketone, ethers having 2 to 4 carbons such as a dimethyl ether, a methyl ethyl ether, a diethyl ether, and a tetrahydrofuran, and organic nitrogen containing compounds having 1 to 4 carbons such as a methyl amine, a dimethyl amine, a trimethyl amine and a dimethyl formamide can be used. Among these examples, water, or alcohols such as a methanol and an ethanol can be used preferably. The above-mentioned additives may be used either alone or as a mixture of two or more kinds.

In the present invention, the above-mentioned InSb nanoparticles are produced in general under an inert gas atmosphere such as an argon gas and a nitrogen gas.

Moreover, in the present invention, in the case the InSb nanoparticle having the same particle size is desired, classification may be carried out. As the method for classifying the InSb nanoparticle according to the particle size, for example, the particle size of the precipitated InSb nanoparticle can be controlled by using a solvent mixture of an affinity solvent having a high affinity with respect to the InSb nanoparticle and a poor solvent having a low affinity, and changing the ratio of the affinity solvent and the poor solvent. This is for utilizing the phenomenon that the InSb nanoparticle having a large particle size is precipitated with a large ratio of the affinity solvent/poor solvent, and the InSb nanoparticle having a small particle size is precipitated together with the smaller ratio. Specifically, first by adding a small amount of the poor solvent to the dispersion prepared by dispersing the InSb nanoparticle in the affinity solvent, only the InSb nanoparticle of a large particle size is precipitated. By separating the precipitation by the centrifugal separation, or the like, the InSb nanoparticle having a large particle size is obtained. Next, by further adding the poor solvent to the dispersion after the centrifugal separation, the InSb nanoparticle having a particle size smaller than that of the prior precipitated InSb nanoparticle is precipitated. By separating the precipitation by the centrifugal separation, or the like, the InSb nanoparticle having a particle size smaller than that of the prior precipitated InSb nanoparticle is obtained. By repeating the addition of the poor solvent and the operation of the centrifugal separation, the classification can be carried out.

As the affinity solvent used for the classification, the dispersion media mentioned in the item of “B. InSb nanoparticle dispersion” can be presented. Moreover, as the poor solvent, the above-mentioned additives used for improving the precipitating property of the InSb nanoparticle can be presented.

Furthermore, according to the present invention, the dispersing agent adhered to the surface of the InSb nanoparticle can be substituted by another organic compound. In this case, by heating a large amount of another organic compound to be substituted and the InSb nanoparticle while mixing under an inert gas atmosphere, the dispersing agent first adhered to the surface of the InSb nanoparticle can be substituted by the other organic compound present by the large amount. The addition amount of the other organic compound to be substituted may be 5 times or more by the weight ratio with respect to the InSb nanoparticle. Moreover, the heating time is in general 1 to 48 hours.

Moreover, according to the present invention, by heating the InSb nanoparticle with the dispersing agent adhered to the surface, the dispersing agent can be eliminated so that the InSb nanoparticle without the dispersing agent adhered to the surface can also be obtained. In this case, for dispersing the InSb nanoparticle in the dispersion medium, a dispersing agent may be added. Thereby, the InSb nanoparticle is in a stage dispersed independently in the dispersion medium.

Furthermore, according to the present invention, in the case of producing the InSb nanoparticle with a minute amount of an element doped, a minute amount of a predetermined element or a compound containing the element is added to the dispersing agent at the time of heating the dispersing agent. Alternatively, a minute amount of a predetermined element or a compound containing the element may be added to the precursor. Since the InSb nanoparticle with the minute amount of the element doped can provide either the n type semiconductor forming material or the p type semiconductor forming material depending on the kind of the element, it is useful as the semiconductor forming material. The compound containing a predetermined element to be added differs depending on the kind of the element to be doped. In the case of producing the InSb nanoparticle to be the n type semiconductor forming material, for example, a tributyl phosphine solvent of Se or Te, a diisopropyl telluride, a tellurium alkoxide, or the like can be used. On the other hand, in the case of producing the InSb nanoparticle to be the p type semiconductor forming material, as the compound containing a predetermined element to be added, for example, a zinc acetate, a cobalt carbonyl, a cadmium chloride, or the like can be used.

The present invention is not limited to the embodiments mentioned above. The embodiments are merely examples, and any one having substantially same configuration as the technological idea disclosed in the scope of the claims of the present invention and the same effects is included in the technological scope of the present invention.

### EXAMPLES

Hereinafter, the present invention will be explained specifically with reference to the examples.

### Example 1

The reaction field of the hot soap method was provided by the below dispersing agent.

| | |
|---|---|
| 1,2-hexadecane diol (produced by ALDRICH) | 1.2 g |
| Oleic acid (produced by ALDRICH) | 1.2 g |
| Hexadecyl amine (produced by KANTO KAGAKU.) | 18 g |

The above-mentioned dispersing agent was mixed in a flask and heated to 300° C. after the substitution by an argon gas atmosphere.

Next, the precursor mixture liquid was prepared by the following composition.

<Precursor Mixture Liquid>

| | |
|---|---|
| n-Butoxy antimony (produced by AZmax.co) | 0.060 g |
| Indium acetyl acetonate (produced by ALDRICH) | 0.090 g |
| 1,2-Dichlorobenzene (produced by KANTO KAGAKU.) | 0.70 g |

After the injection of the precursor mixture liquid to the reaction field, the temperature was raised to 295° C. so as to be maintained at the temperature for 30 minutes. Thereafter, the reaction solution was cooled down by the air. At the time it was cooled down to 60° C., 50 ml of an ethanol was added. Then, after separating the black precipitate by the centrifugal separation, a purification was carried out by the re-precipitation according to the procedure described below.

That is, by mixing the black precipitate with 3 g of a chloroform and mixing the dispersion with 12 g of an ethanol, a purified black precipitate was obtained.

According to the centrifugal separation of the re-precipitation liquid accordingly obtained, a purified black powder “a” was obtained.

FIG. 1A is a transmission electron microscope (TEM) photograph of the obtained black powder “a”. From the TEM photograph of FIG. 1A, it was observed that the black powder “a” was particles of a 7 to 50 nm particle size.

Moreover, FIG. 2(a) shows the X ray diffraction pattern of the black powder “a”. FIG. 2(b) shows the X ray diffraction pattern (JCPDS No. 60208) of the InSb. From the X ray diffraction pattern of FIG. 2, it was confirmed that the black particle “a” has an InSb crystal structure.

Furthermore, it was confirmed that the black powder “a” can be dispersed in a chloroform. Using the X ray photoelectron spectrometry (XPS), it was confirmed that a carbon, a nitrogen contained in an amino group, a carboxyl group, and oxygen contained in a hydroxyl group were included. Thereby, adhesion of the dispersing agent to the surface of the black powder “a” was confirmed.

### Example 2

After obtaining a dispersion by mixing the black powder “a” obtained in the example 1 with a chloroform, an ethanol was dropped into the dispersion until precipitation was generated. By separating the obtained black precipitant by the centrifugal separation from the re-precipitation liquid, a black powder “b” was obtained.

According to the transmission electron microscope observation, it was observed that the obtained black powder “b” was a particle having a 40 nm average particle size.

Next, an ethanol was dropped into the re-precipitation liquid separated at the time of obtaining the black powder “b” until precipitation was generated. By separating the obtained black precipitant by the centrifugal separation from the re-precipitation liquid, a black powder “c” was obtained.

According to the transmission electron microscope observation, it was observed that the obtained black powder “c” was a particle having a 20 nm average particle size.

Next, an ethanol was dropped into the re-precipitation liquid separated at the time of obtaining the black powder “c” until precipitation was generated. By separating the obtained black precipitant by the centrifugal separation from the re-precipitation liquid, a black powder “d” was obtained.

According to the transmission electron microscope observation, it was observed that the obtained black powder “d” was a particle having a 10 nm average particle size.

### Example 3

The black powder “a” obtained in the example 1 was mixed with the following organic compound under the argon gas atmosphere, heated to 150° C. and agitated for 6 hours.

| | |
|---|---|
| Black powder “a” | 0.1 g |
| 3-mercapto propionic acid | 5.0 g |

The obtained dark brown precipitant was separated from the unreacted 3-mercapto propionic acid by the centrifugal separation and washed with a chloroform. Thereafter, by the reduced-pressure drying, a dark brown powder was obtained. The obtained dark brown powder was not dispersed in a chloroform but dispersed in a N,N-dimethyl formamide.

### Example 4

In the same manner as in the example 1 except that the reaction field of the hot soap method was provided with the following dispersing agent in the example 1, a black powder “e” was obtained.

<Dispersing Agent>

| | |
|---|---|
| 1,2-hexadecane diol (produced by ALDRICH) | 0.53 g |
| Oleic acid (produced by ALDRICH) | 0.16 g |
| Hexadecyl amine (produced by KANTO KAGAKU.) | 18 g |

According to the transmission electron microscope observation, it was confirmed that the obtained black powder “e” is a particle having a 10 to 200 nm particle size. Moreover, according to the X ray diffraction analysis, it was confirmed that the black powder “e” has an InSb crystal structure.

Furthermore, according to the method mentioned above, it was confirmed that a carbon, a nitrogen contained in an amino group, a carboxyl group, and oxygen contained in a hydroxyl group were included in the surface of the black powder “e”. Thereby, adhesion of the dispersing agent to the surface of the black powder “e” was confirmed.

### Example 5

In the same manner as in the example 1 except that the injection temperature of the precursor liquid mixture was changed to 325° C. and the temperature to be maintained for 30 minutes after the injection was changed to 310° C., a black powder “f” was obtained.

According to the transmission electron microscope observation, it was confirmed that the obtained black powder “f” is a particle having a 2 to 50 nm particle size. Moreover, according to the X ray diffraction analysis, it was confirmed that the black powder “f” has an InSb crystal structure.

Furthermore, according to the method, it was confirmed that a carbon, a nitrogen contained in an amino group, a carboxyl group, and oxygen contained in a hydroxyl group were included in the surface of the black powder “f”. Thereby, adhesion of the dispersing agent to the surface of the black powder “f” was confirmed.

### Example 6

By mixing the black powders “a”, “e”, “f” obtained in the examples 1, 4, 5 with a chloroform, dispersions “a”, “e”, “f” were obtained. Moreover, by mixing the dark brown powder obtained in the example 3 with a N,N-dimethyl formamide, a dispersion “g” was obtained. The time needed for generating the precipitation of the black powders (InSb nanoparticle) with the dispersions “a”, “e”, “f”, “g” leaving still in an environment with the 20° C. temperature and 60% humidity was measured. The results are shown in the table 1.

TABLE 1

| | Content of the | Time needed for |
|---|---|---|
| | InSb nanoparticle | generating the |
| | (% by weight) | precipitation (hour) |
| Dispersion “a” | 0.2 | 12 or more |
| (black powder “a”) | | |
| Dispersion “e” | 0.2 | 6 or more |
| (black powder “e”) | | |
| Dispersion “f” | 0.2 | 12 or more |
| (black powder “f”) | | |
| Dispersion “g” | 0.2 | 12 or more |
| (darkbrownpowder) | | |

From the table 1, the dispersions “a”, “e”, “f”, “g” have the InSb nanoparticle dispersed independently.

What is claimed is:

1. An InSb nanoparticle having an average particle size in a range of 2 nm to 200 nm, capable of being dispersed and to be dispersed independently in a dispersion medium.

2. The InSb nanoparticle according to claim 1, wherein an organic compound having one or more residues of a hydrophilic group and a hydrophobic group in one molecule is adhered on a surface.

3. An InSb nanoparticle having one or more residues of a hydrophilic group and a hydrophobic group in one molecule adhered on a surface.

4. The InSb nanoparticle according to claim 2, wherein the hydrophilic group is an amino group, a carboxyl group or a hydroxyl group.

5. The InSb nanoparticle according to claim 3, wherein the hydrophilic group is an amino group, a carboxyl group or a hydroxyl group.

6. An InSb nanoparticle dispersion containing an InSb nanoparticle and a dispersion medium.

7. The InSb nanoparticle dispersion according to claim 6, wherein the InSb nanoparticle is dispersed independently in the dispersion medium.

8. The InSb nanoparticle dispersion according to claim 6, wherein the InSb nanoparticle has an organic compound having a hydrophilic group and a hydrophobic group in one molecule adhered on a surface and the dispersion medium is a non polar solvent.

9. The InSb nanoparticle dispersion according to claim 7, wherein the InSb nanoparticle has an organic compound having a hydrophilic group and a hydrophobic group in one molecule adhered on a surface and the dispersion medium is a non polar solvent.

10. The InSb nanoparticle dispersion according to claim 6, wherein the InSb nanoparticle has an organic compound having a hydrophilic group and a hydrophobic group in one molecule with the hydrophilic group bonded to both ends of the hydrophobic group adhered on a surface and the dispersion medium is a polar solvent.

11. The InSb nanoparticle dispersion according to claim 7, wherein the InSb nanoparticle has an organic compound having a hydrophilic group and a hydrophobic group in one molecule with the hydrophilic group bonded to both ends of the hydrophobic group adhered on a surface and the dispersion medium is a polar solvent.

12. A method for producing an InSb nanoparticle, wherein an InSb nanoparticle is produced by a hot soap method.

13. The method for producing an InSb nanoparticle according to claim 12, wherein at least one organic compound selected from a group consisting of amino alkanes, higher fatty acids, and higher alcohols is used in the hot soap method.

14. The method for producing an InSb nanoparticle according to claim 12, wherein the higher alcohols having one or more residues of a long chain alkyl group and two or more residues of a hydroxyl group in one molecule are used in the hot soap method.

15. The method for producing an InSb nanoparticle according to claim 13, wherein the higher alcohols having one or more residues of a long chain alkyl group and two or more residues of a hydroxyl group in one molecule are used in the hot soap method.
